(19) United States
(12) Patent Application Publication
(10) Pub. No.: US 2014/0136793 A1
(43) Pub. Date: May 15, 2014

(54) SYSTEM AND METHOD FOR REDUCED CACHE MODE

(71) Applicant: NVIDIA CORPORATION, Santa Clara, CA (US)

(72) Inventors: James Patrick Robertson, Austin, TX (US); Oren Rubinstein, Sunnyvale, CA (US); Michael A. Woodmansee, Lighthouse Point, FL (US); Don Bittel, San Jose, CA (US); Stephen D. Lew, Sunnyvale, CA (US); Edward Riegelsberger, Fremont, CA (US); Brad W. Simeral, San Francisco, CA (US); Gregory Alan Muthler, Austin, TX (US); John Matthew Burgess, Austin, TX (US)

(73) Assignee: NVIDIA CORPORATION, Santa Clara, CA (US)

(21) Appl. No.: 13/676,041

(22) Filed: Nov. 13, 2012

(51) Int. Cl. G06F 12/08

(52) U.S. Cl. CPC G06F 12/0891
USPC 711/135

(57) ABSTRACT

A system and method are described for dynamically changing the size of a computer memory such as level 2 cache as used in a graphics processing unit. In an embodiment, a relatively large cache memory can be implemented in a computing system so as to meet the needs of memory intensive applications. But where cache utilization is reduced, the capacity of the cache can be reduced. In this way, power consumption is reduced by powering down a portion of the cache.

### BACKGROUND OF THE INVENTION

1. Field of the Invention

The present invention generally relates to memory systems and more specifically to approaches for operating in a reduced cache mode.

2. Description of the Related Art

As computing power has increased, so too has the memory capacity of computing systems. Among the various types of memory, including RAM, ROM, cache, dynamic RAM, static RAM, Flash memory, virtual memory, graphics memory, and BIOS, each has increased in capacity as computer power and computer demands have increase.

For example, through the years, the sizes of cache memories have increase. Benefits of larger cache memories include improving system performance. Generally, cache is used by computer processing unit to reduce the average time to access memory. Whereas accessing external dynamic RAM may introduce a relatively significant latency, accessing the more closely integrated cache can reduce latency. The cache is generally a smaller but faster memory that stores copies of the data from the most frequently used main memory (e.g., dynamic RAM) locations. When most memory accesses are cached memory locations, the average latency of memory accesses will be closer to the cache latency than to the latency of main memory. This can provide a significant performance advantage.

With larger memories, however, there is also increased power demand. Especially in battery operated systems, power consumption is a significant issue. In conventional systems, an important engineering tradeoff occurs when deciding on the size of a memory. For example, in choosing the size of a cache, a larger memory can significantly improve performance but can also increase power consumption.

In a system that is intended to have a higher cache utilization, a larger cache can be justified. Conversely, a system with a lower cache utilization, may only need a smaller cache. A more difficult situation is a system that can be expected to operate in varied environments with different levels of cache utilization. In such situations, the systems are oftentimes limited to fixed cache memory sizes that may not be appropriate for all situations.

Accordingly, what is needed in the art is a technique for dynamically changing memory configurations depending on its utilization.

### SUMMARY OF THE INVENTION

Disclosed are techniques for dynamically changing a memory configuration depending on its utilization, which allows the memory to be more effectively used in a wider variety of scenarios. For example, in an embodiment of the present invention, a relatively large cache memory can be implemented in a computing system so as to meet the needs of memory intensive applications. But where cache utilization is reduced, the capacity of the cache can be reduced. In this way, power consumption is reduced by powering down a portion of the cache.

An embodiment of the present invention is implemented to control the size of level 2 cache in a graphics processing unit. In such an embodiment, an instruction is received to operate in a reduced cache mode. This instruction can be automatically generated or manually generated by a user. In this embodiment the cache is prepared for a reduced mode of operation by setting it to a write-through mode and a no-allocate mode. Among other things, this assures that the memory to be reduced does not receive any further data.

Because the memory locations that will no longer be used may contain new data that is not in other memory, such memory locations are flushed of their data such as by writing their data to RAM. Where the memory may be expected to be dynamically increased later, an evict operation can further be implemented so that the memory locations that will no longer be used will not contain unknown data. In this embodiment, the identified portions of the cache can be powered down and normal operations at a reduced memory size can be initiated.

These and other embodiments are described in further detail below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention.

FIG. 2 is a block diagram of a parallel processing subsystem for the computer system of FIG. 1, according to one embodiment of the present invention.

FIG. 3A is a block diagram of a GPC within one of the PPUs of FIG. 2, according to one embodiment of the present invention.

FIG. 3B is a block diagram of a partition unit within one of the PPUs of FIG. 2, according to one embodiment of the present invention.

FIG. 4 is a flow diagram of method steps for implementing a reduced cache mode, according to one embodiment of the present invention.

FIG. 5 is a flow diagram of method steps for implementing a reduced cache mode, according to one embodiment of the present invention.

FIG. 6 is a flow diagram of method steps for implementing an increased cache mode, according to one embodiment of the present invention.

FIG. 7 is a flow diagram of method steps for implementing an increased cache mode, according to one embodiment of the present invention.

### DETAILED DESCRIPTION

In the following description, numerous specific details are set forth to provide a more thorough understanding of the present invention. It will, however, be apparent to one of skill in the art that the present invention may be practiced without one or more of these specific details. In other instances, well-known features have not been described in order to avoid obscuring the present invention.

### System Overview

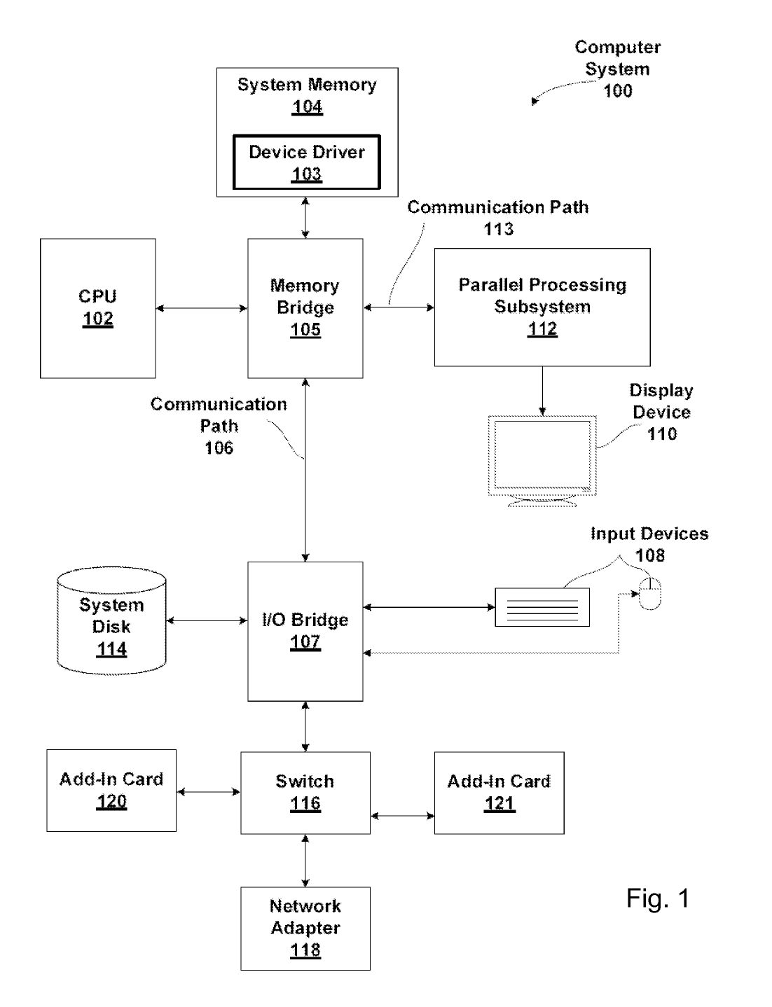

FIG. 1 is a block diagram illustrating a computer system 100 configured to implement one or more aspects of the present invention. Computer system 100 includes a central processing unit (CPU) 102 and a system memory 104 communicating via a bus path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

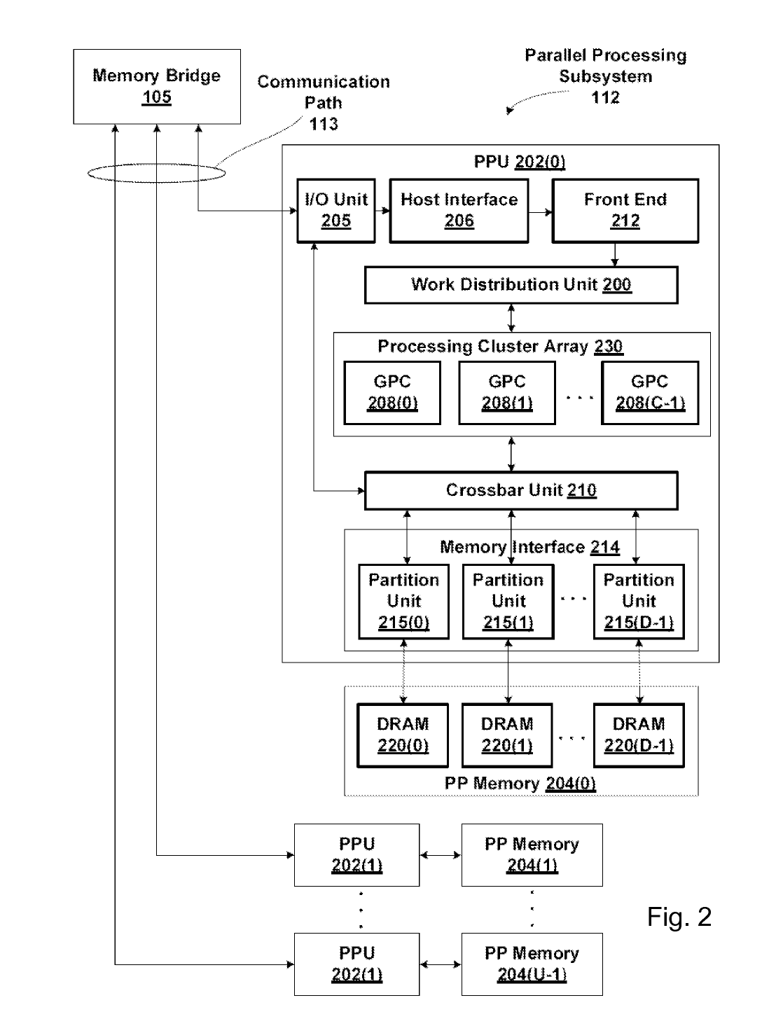

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer (not explicitly shown in either FIG. 1 or FIG. 2) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-E link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in screen space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the partition units 215 within parallel processing memory 204. Crossbar unit 210 is an interconnect that is configured to route the output of each GPC 208 to the input of any partition unit 214 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-E) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Processing Cluster Array Overview

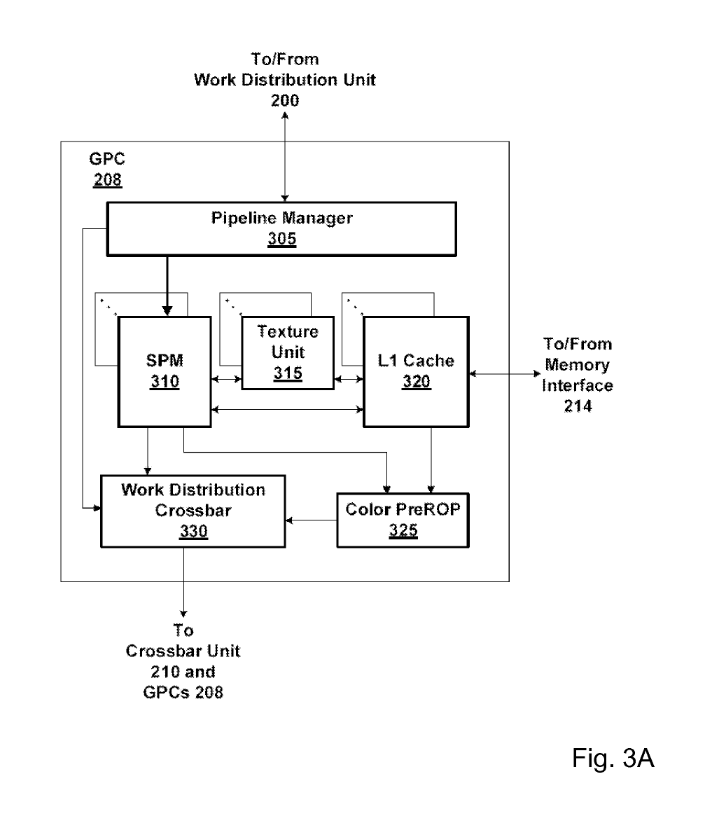

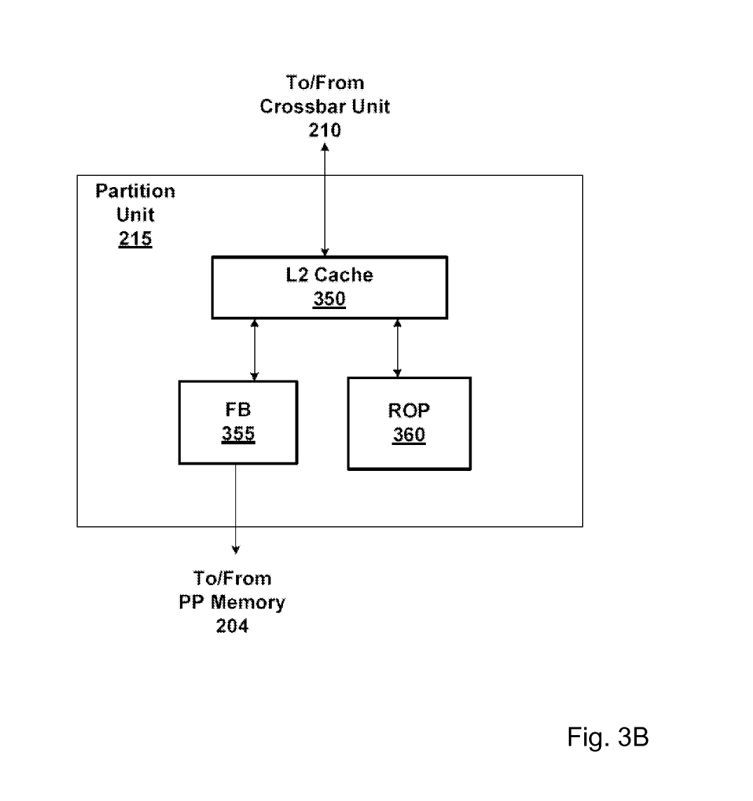

FIG. 3A is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

In graphics applications, a GPU 208 may be configured to implement a primitive engine for performing screen space graphics processing functions that may include, but are not limited to primitive setup, rasterization, and z culling. The primitive engine receives a processing task from work distribution unit 200, and when the processing task does not require the operations performed by primitive engine, the processing task is passed through the primitive engine to a pipeline manager 305. Operation of GPC 208 is advantageously controlled via a pipeline manager 305 that distributes processing tasks to streaming multiprocessors (SPMs) 310. Pipeline manager 305 may also be configured to control a work distribution crossbar 330 by specifying destinations for processed data output by SPMs 310.

In one embodiment, each GPC 208 includes a number M of SPMs 310, where M≧1, each SPM 310 configured to process one or more thread groups. Also, each SPM 310 advantageously includes an identical set of functional units (e.g., arithmetic logic units, etc.) that may be pipelined, allowing a new instruction to be issued before a previous instruction has finished, as is known in the art. Any combination of functional units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SPM 310 is referred to herein as a “thread group.” As used herein, a “thread group” refers to a group of threads concurrently executing the same program on different input data, with each thread of the group being assigned to a different processing engine within an SPM 310. A thread group may include fewer threads than the number of processing engines within the SPM 310, in which case some processing engines will be idle during cycles when that thread group is being processed. A thread group may also include more threads than the number of processing engines within the SPM 310, in which case processing will take place over multiple clock cycles. Since each SPM 310 can support up to G thread groups concurrently, it follows that up to G×M thread groups can be executing in GPC 208 at any given time.

An exclusive local address space is available to each thread, and a shared per-CTA address space is used to pass data between threads within a CTA. Data stored in the per-thread local address space and per-CTA address space is stored in L1 cache 320, and an eviction policy may be used to favor keeping the data in L1 cache 320. Each SPM 310 uses space in a corresponding L1 cache 320 that is used to perform load and store operations. Each SPM 310 also has access to L2 caches within the partition units 215 that are shared among all GPCs 208 and may be used to transfer data between threads. Finally, SPMs 310 also have access to off-chip “global” memory, which can include, e.g., parallel processing memory 204 and/or system memory 104. An L2 cache may be used to store data that is written to and read from global memory. It is to be understood that any memory external to PPU 202 may be used as global memory.

In graphics applications, a GPC 208 may be configured such that each SPM 310 is coupled to a texture unit 315 for performing texture mapping operations, e.g., determining texture sample positions, reading texture data, and filtering the texture data. Texture data is read via memory interface 214 and is fetched from an L2 cache, parallel processing memory 204, or system memory 104, as needed. Texture unit 315 may be configured to store the texture data in an internal cache. In some embodiments, texture unit 315 is coupled to L1 cache 320, and texture data is stored in L1 cache 320. Each SPM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SPM 310, direct data to ROP units within partition units 215, and perform optimizations for color blending, organize pixel color data, and perform address translations.

It will be appreciated that the core architecture described herein is illustrative and that variations and modifications are possible. Any number of processing engines, e.g., primitive engines 304, SPMs 310, texture units 315, or preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing engines, L1 caches 320, and so on.

FIG. 3B is a block diagram of a partition unit 215 within on of the PPUs 202 of FIG. 2, according to one embodiment of the present invention. As shown, partition unit 215 includes a L2 cache 350, a frame buffer (FB) 355, and a raster operations unit (ROP) 360. L2 cache 350 is a read/write cache that is configured to perform load and store operations received from crossbar unit 210 and ROP 360. Read misses and urgent writeback requests are output by L2 cache 350 to frame buffer logic 355 for processing. Dirty updates are also sent to frame buffer logic 355 for opportunistic processing. frame buffer logic 355 interfaces directly with parallel processing memory 204, outputting read and write requests and receiving data read from parallel processing memory 204.

In graphics applications, ROP 360 is a processing unit that performs raster operations, such as stencil, z test, blending, and the like, and outputs pixel data as processed graphics data for storage in graphics memory. In some embodiments of the present invention, ROP 360 is included within each GPC 208 instead of partition unit 215, and pixel read and write requests are transmitted over crossbar unit 210 instead of pixel fragment data.

The processed graphics data may be displayed on display device 110 or routed for further processing by CPU 102 or by one of the processing entities within parallel processing subsystem 112. Each partition unit 215 includes a ROP 360 in order to distribute processing of the raster operations. In some embodiments, ROP 360 may be configured to compress z or color data that is written to memory and decompress z or color data that is read from memory.

Persons skilled in the art will understand that the architecture described in FIGS. 1, 2, 3A and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

### Reduced Cache Mode

An embodiment of the present invention implements a dynamically reduced cache mode that provides various advantages in a computer system. For example, because the size of a cache can be dynamically reduced, a system designer is free to implement a relatively large cache to meet the needs of memory intensive applications but is able to reduce the size of the cache in situations of reduced cache utilization or where reduced power consumption is desired. Through the implementation of a dynamically reduced cache mode, a computing system has improved flexibility to meet the needs of many situations.

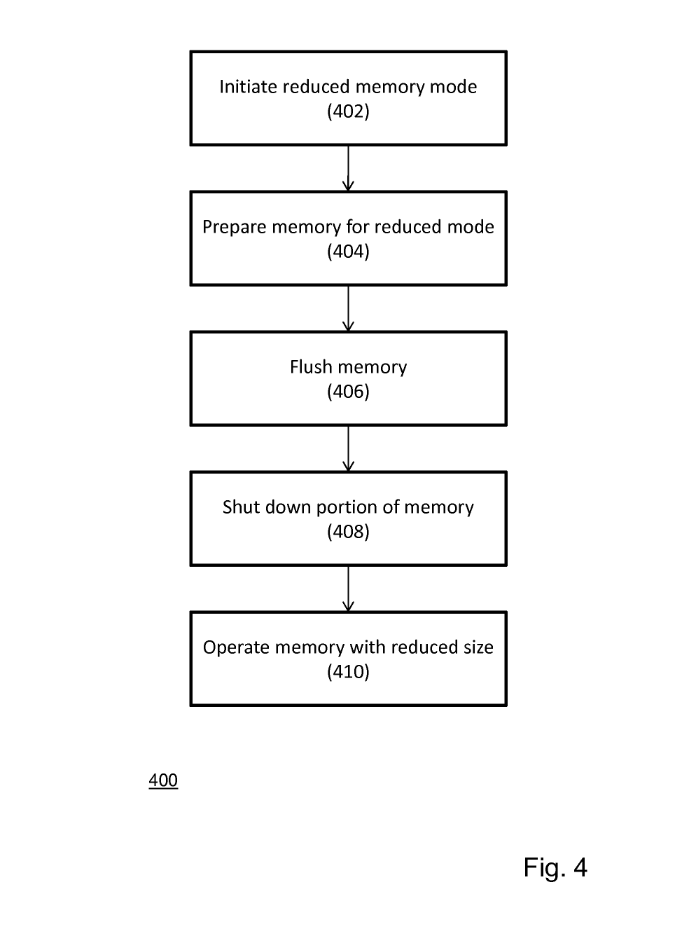

Shown in FIG. 4 is a flow diagram of method steps for implementing a dynamically reduced memory mode. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

In an embodiment of the present invention, an instruction is provided at step 402 to implement a reduced memory mode. The instruction at step 402 can be generated automatically by, for example, a central processing unit 102 or graphics processing unit 208. For example, in a situation where memory utilization has been low for a predetermined time, step 402 can be generated automatically. Alternatively, the instruction at step 402 can be generated manually. For example, where a user of a computing system desired to reduce power consumption, the instruction at step 402 can be generated by the user. The instruction at step 402 can be generated in other manners as would be known to those of ordinary skill in the art.

At step 404, the memory (e.g., memory 104 or cache 320) is prepared for the reduced mode. Among other things, a memory controller such as may be included in a memory crossbar unit 210 may implement certain of the steps 404-410 of FIG. 4. Because of the traditional implementations of memory, an embodiment of the present invention, reduces the size of the memory by powers of two. For example, the size of the memory is optionally set to be reduced by ½, ¼, ⅛/ and so on. So as to dynamically reduce the memory mode, the memory must first be prepared for the reduced operation. For example, in reducing the size of the memory, an embodiment of the present invention eliminates the highest order memory locations. For example, for a data array with memory sets 0-511 that is desired to be reduced by ½, sets 256-511 are disabled. In this situation, at step 404, the sets to be disabled are identified and prepared for shutting down.

At step 404, the memory (e.g., memory 104 or cache 320) can further be prepared for the reduced mode by bypassing its normal operation. For example, the identified memory that is to be shut down are configured so as not to receive any new data (e.g., cannot write to memory locations that are to be shut down).

Because the memory (e.g., memory 104 or cache 320) may contain valid information, its contents are flushed at step 406. In an embodiment, the flushing operation further includes an evict operation so as not to risk receiving incorrect data during a subsequent change in the size of the memory. In an embodiment of the present invention, the flushing operation of step 406 includes reading each of the memory locations that are to be shut down and storing their contents in an alternative location. For example, where method 400 is implemented in Level 2 cache, the contents of the memory locations that are to be shut down are written to dynamic RAM. In an embodiment of the present invention, step 406 is applied to the entire memory before shutting down any portion of the memory. Step 406 can be applied in other manners as would be known to those of ordinary skill in the art.

The identified portion of memory (e.g., memory 104 or cache 320) is shut down at step 408. At step 410, the memory is configured to operate in the reduced mode. For example, where only memory sets 0-255 are available, the addressing scheme is configured accordingly. In an embodiment of the present invention, a tag bit is implemented in the addressing scheme to indicate that the memory is operating in a reduced mode.

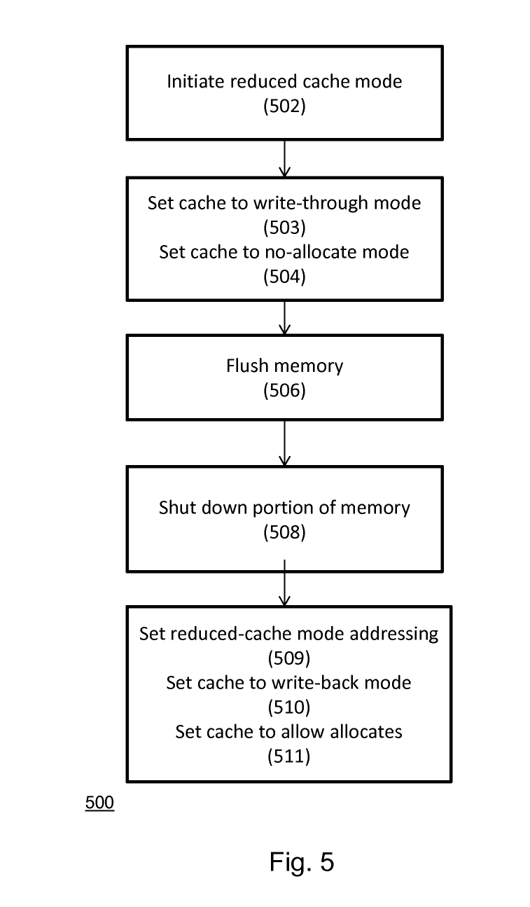

The methods and techniques of the present invention can be applied in different types of memory. Shown in FIG. 5 is a flow diagram of method steps for a dynamically reduced Level 2 cache mode (see, e.g., cache 320 of FIG. 3A). So as to provide concrete examples, an embodiment of the present invention will be described for an application in a graphics processing unit, and, more particularly, as implemented in Level 2 cache within the graphics processing unit. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

In an embodiment of the present invention, an instruction is provided at step 502 to implement a reduced memory mode. In this embodiment, the instruction is generated by the GPU 208. The instruction at step 502 can be generated automatically. For example, in a situation where cache utilization has been low for a predetermined time, step 502 can be generated automatically. Alternatively, the instruction at step 502 can be generated manually. For example, where a user of GPU desired to reduce power consumption, the instruction at step 502 can be generated by the user. The instruction at step 502 can be generated in other manners as would be known to those of ordinary skill in the art.

At steps 503 and 504, the memory (e.g., cache 320 of FIG. 3A) is prepared for the reduced cache mode. Among other things, a memory controller such as may be included in a memory crossbar unit 210 may implement certain of the steps 503-511 of FIG. 5. Because of the traditional implementations of memory, an embodiment of the present invention, reduces the size of the memory by powers of two. For example, the size of the memory is optionally set to be reduced by ½, ¼, ⅛/ and so on. So as to dynamically reduce the memory mode, the memory must first be prepared for the reduced operation. For example, in reducing the size of the memory, an embodiment of the present invention eliminates the highest order memory locations. For example, for a data array with memory sets 0-511 that is desired to be reduced by ½, memory sets 256-511 are disabled. In this situation, the memory sets to be disabled are identified and prepared for shutting down. At step 503, the identified memory locations are set to a write-through mode. In this mode any memory writes are not performed on the cache but are instead passed through to the RAM. In this way, it can be assured that the cache will not contain any new data. Also, at step 504, the identified memory locations are set to a no-allocate mode. In this mode, the identified memory locations are prohibited from being allocated for storage operations.

Because the cache may contain dirty data, its contents are flushed at step 506. In an embodiment, the flushing operation further includes an evict operation so as not to risk receiving incorrect data during a subsequent change in the size of the memory. In an embodiment of the present invention, the flushing operation of step 506 includes reading each of the cache locations that are to be shut down and storing their contents in RAM. In an embodiment of the present invention, step 506 is applied to only the cache that is to be shut down. In another embodiment of the present invention, step 506 is applied to the entire cache before shutting down any portion of the cache. Step 506 can be applied in other manners as would be known to those of ordinary skill in the art.

The identified portion of cache (e.g., cache 320 of FIG. 3A) is shut down at step 508. At step 509, the cache is configured to operate with an addressing scheme to match the size of the newly configured cache. For example, where only memory sets 0-255 are available, the addressing scheme is configured accordingly. In an embodiment of the present invention, a tag bit is implemented in the addressing scheme to indicate that the memory is operating in a reduced mode.

To further prepare the cache (e.g., cache 320 of FIG. 3A) for normal operation at its reduced size, at step 510, the cache is set to a write-back mode where the cache can receive new information (e.g., cache write operations). Also, at step 511, the cache is set to a allow-allocates mode where cache memory locations can be allocated to receive new information. At this point, the cache is now ready for normal operations at its reduced size.

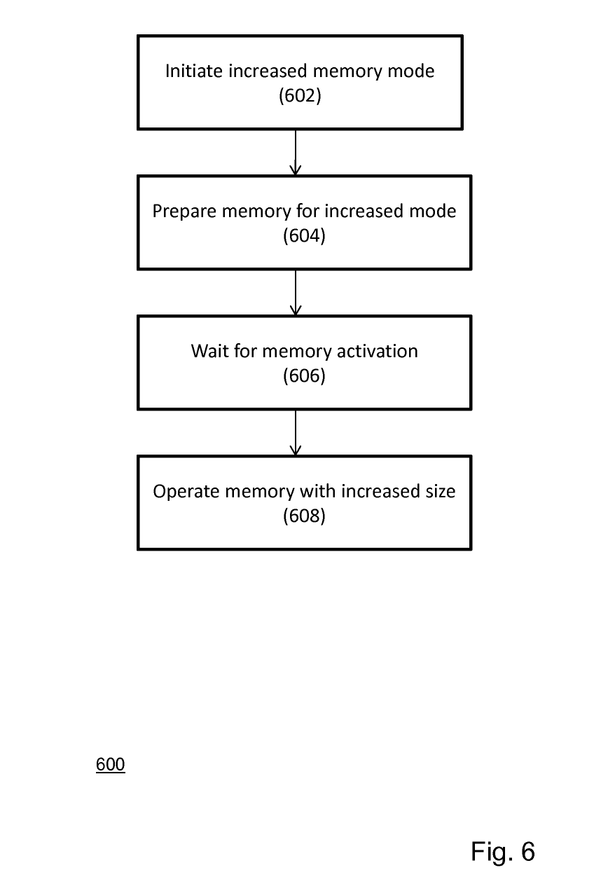

An embodiment of the present invention is further able to exit from a reduced cache mode and increase the available cache. Shown in FIG. 6 is a flow diagram of method steps for dynamically increasing memory mode. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

In an embodiment of the present invention, an instruction is provided at step 602 to implement an increased memory mode. The instruction at step 602 can be generated automatically by, for example, a central processing unit 102 or graphics processing unit 208. For example, in a situation where memory utilization has been high for a predetermined time, step 602 can be generated automatically. Alternatively, the instruction at step 602 can be generated manually. For example, where a user of a computing system desired to increase computation capabilities, the instruction at step 602 can be generated by the user. The instruction at step 602 can be generated in other manners as would be known to those of ordinary skill in the art.

At step, 604, the memory (e.g., memory 104 or cache 320) is prepared for the increased memory mode. Among other things, a memory controller such as may be included in a memory crossbar unit 210 may implement certain of the steps 604-608 of FIG. 6. Because of the traditional implementations of memory, an embodiment of the present invention, increases the size of the memory by powers of two. For example, the size of the memory is optionally set to be increased by 8, 4, 2, ½, ¼, ⅛/ and so on. So as to dynamically increase the memory mode, the memory must first be prepared for the increased operation. For example, the identified memory is enabled by providing power to it. Also, in increasing the size of the memory, an embodiment of the present invention introduces higher order memory locations and correspondingly initiates higher order addressing. For example, for a data array using memory sets 0-255 that is desired to be reduced by 2, memory sets 256-511 are enabled. In this situation, at step 604, the memory sets to be enabled are identified and prepared for operation.

Activation of the memory (e.g., memory 104 or cache 320) can take time and may require waiting as in step 606. In an embodiment, the method waits for a predetermined amount of time before normal memory operations are initiated at step 608. In another embodiment, a signal is received from the memory indicating that the memory is ready for normal operations with increased memory. Still other techniques for assuring that the memory is ready for normal operation would be known to those of ordinary skill in the art.

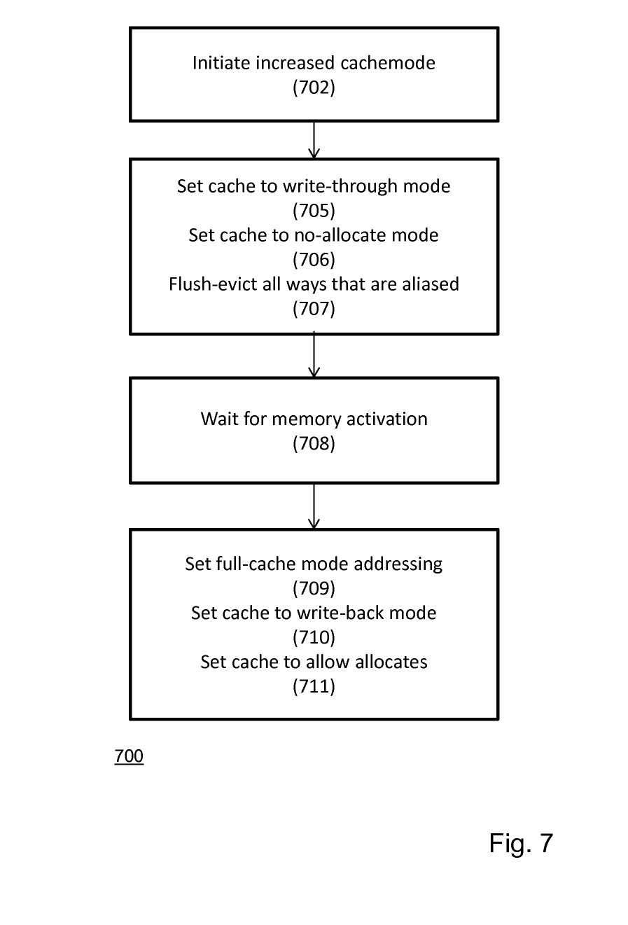

The methods and techniques of the present invention can be applied in different types of memory. Shown in FIG. 7 is a flow diagram of method steps for dynamically increasing a Level 2 cache mode (see, e.g., cache 320 of FIG. 3A). So as to provide concrete examples, an embodiment of the present invention will be described for an application in a graphics processing unit, and, more particularly, as implemented in Level 2 cache within the graphics processing unit. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

In an embodiment of the present invention, an instruction is provided at step 702 to implement a reduced memory mode. In this embodiment, the instruction is generated by the GPU 208. The instruction at step 702 can be generated automatically. For example, in a situation where cache utilization has been high for a predetermined time, step 702 can be generated automatically. Alternatively, the instruction at step 702 can be generated manually. For example, where a user of a computing system desired to increase computation capabilities, the instruction at step 702 can be generated by the user. The instruction at step 702 can be generated in other manners as would be known to those of ordinary skill in the art.

At steps 705, 706, and 707, the cache (e.g., cache 320 of FIG. 3A) is prepared for the increased cache mode. Among other things, a memory controller such as may be included in a memory crossbar unit 210 may implement certain of the described steps. Because of the traditional implementations of memory, an embodiment of the present invention, increases the size of the memory by powers of two. For example, the size of the memory is optionally set to be increased by 8, 4, 2, ½, ¼, ⅛/ and so on. So as to dynamically increase the memory mode, the memory must first be prepared for the increased operation. For example, the identified memory is enabled by providing power to it. Also, in increasing the size of the memory, an embodiment of the present invention introduces higher order memory locations and correspondingly initiates higher order addressing. For example, for a data array using memory sets 0-255 that is desired to be reduced by 2, memory sets 256-511 are enabled. In this situation, at step 604, the memory sets to be enabled are identified and prepared for operation.

At step 705, the identified memory locations are set to a write-through mode. In this mode any memory writes are not performed on the cache but are instead passed through to the RAM. In this way, it can be assured that the cache will not contain any new data. Also, at step 706, the identified memory locations are set to a no-allocate mode. In this mode, the identified memory locations are prohibited from being allocated for storage operations.

Because the cache may dirty data, its contents are flushed at step 707. In an embodiment, the flushing operation further includes an evict operation so as not to risk receiving incorrect data during a subsequent change in the size of the memory. In an embodiment of the present invention, the flushing operation of step 707 includes reading each of the cache locations that are to be shut down and storing their contents in RAM. In an embodiment of the present invention, step 707 is applied to the entire cache before enabling any new portion of the cache. Step 707 can be applied in other manners as would be known to those of ordinary skill in the art.

Activation of the cache can take time and may require waiting as in step 606. In an embodiment, the method waits for a predetermined amount of time before normal memory operations are initiated at step 708. In another embodiment, a signal is received from the memory indicating that the memory is ready for normal operations with increased memory. Still other techniques for assuring that the memory is ready for normal operation would be known to those of ordinary skill in the art.

At step 709, the cache is configured to operate with an addressing scheme to match the size of the newly configured expanded cache. For example, where only memory sets 0-255 were previously available and the cache is expanded to include memory sets 256-511, the addressing scheme is configured accordingly. In an embodiment of the present invention, a tag bit is implemented in the addressing scheme to indicate that the memory is operating in an increased mode.

To further prepare the cache for normal operation at its increased size, at step 710, the cache is set to a write-back mode where the cache can receive new information (e.g., cache write operations). Also, at step 711, the cache is set to an allow-allocates mode where cache memory locations can be allocated to receive new information. At this point, the cache is now ready for normal operations at its increased size.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., Flash media or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A method for dynamically changing an operational size of a memory within a computing device, the method comprising:
receiving an indication to operate in a reduced memory mode;
identifying a portion of the memory to be disabled;
preparing the memory to operate in the reduced memory mode;
flushing the contents of the portion of the memory to be disabled;
shutting down the portion of the memory to be disabled; and
operating the memory in the reduced memory mode.

2. The method of claim 1, wherein the memory is a cache memory.

3. The method of claim 1, further comprising evicting contents from the portion of the memory to be disabled.

4. The method of claim 1, wherein preparing the memory to operate in the reduced mode includes configuring the memory to operate in a write-through mode.

5. The method of claim 1, wherein preparing the memory to operate in the reduced mode includes configuring the memory to operate in a no-allocate mode.

6. The method of claim 1, wherein operating the memory in the reduced mode includes operating the memory with a reduced addressing scheme.

7. The method of claim 1, wherein operating the memory in the reduced mode includes setting configuring the memory to operate in a write-back mode.

8. The method of claim 1, wherein operating the memory in the reduced mode includes setting configuring the memory to operate in an allow-allocates mode.

9. The method of claim 1, wherein the indication to operate in a reduced memory mode is generated in response to a low utilization of the memory.

10. A memory system, comprising:
a memory controller circuitry configured to:
receive an indication to operate a memory in a reduced memory mode;
identify a portion of the memory to be disabled;
prepare the memory to operate in the reduced memory mode;
flush the contents of the portion of the memory to be disabled;
shut down the portion of the memory to be disabled; and
operate the memory in the reduced memory mode.

11. The system of claim 11, wherein the memory is partitioned into a plurality of portions.

12. The system of claim 11, wherein the memory is a cache memory.

13. The system of claim 10, wherein the memory controller is further configured to evict contents from the portion of the memory to be disabled.

14. The system of claim 10, wherein preparing the memory to operate in the reduced mode includes configuring the memory to operate in a write-through mode.

15. The system of claim 11, wherein preparing the memory to operate in the reduced mode includes configuring the memory to operate in a no-allocate mode.

16. The system of claim 11, wherein operating the memory in the reduced mode includes operating the memory with a reduced addressing scheme.

17. The system of claim 11, wherein operating the memory in the reduced mode includes configuring the memory to operate in a write-back mode.

18. The system of claim 11, wherein operating the memory in the reduced mode includes configuring the memory to operate in an allow-allocates mode.

19. The system of claim 11, wherein indication to operate in a reduced memory mode is generated responsive to a low utilization of the memory.

20. A computing device comprising:
a data bus;
a memory unit coupled to the data bus;
a memory subsystem coupled to the data bus and configured to
receive an indication to operate the memory in a reduced memory mode;
identify a portion of the memory to be disabled;
prepare the memory to operate in the reduced memory mode;
flush the contents of the portion of the memory to be disabled;
shut down the portion of the memory to be disabled; and
operate the memory in the reduced memory mode.
